(19) United States
(12) Patent Application Publication
(10) Pub. No.: US 2016/0363349 A1
(43) Pub. Date: Dec. 15, 2016

(54) METHOD FOR PRODUCING AN ELEMENT FOR ABSORBING SOLAR RADIATION FOR A CONCENTRATING SOLAR THERMAL POWER PLANT, ELEMENT FOR ABSORBING SOLAR RADIATION

(71) Applicants: COMMISSARIAT Ä L'ENERGIE ATOMIQUE ET AUX ENERGIES ALTERNATIVES, Paris (FR); SALZGITTER MANNESMANN PRECISION ETIRAGE SAS, St-Florentin (FR)

(72) Inventors: Gatien FLEURY, Gréoux-les-Bains (FR); Raphaël COUTURIER, Sassenage (FR); Olivier SICARDY, Saint-Egrève (FR); Carole MOLLARD, Panissage (FR); Benoit BOULAY, Neuvy Sautour (FR); Jean-Marc DUHAMEL, Vitry-le-Francois (FR)

(73) Assignees: COMMISSARIAT Ä L'ENERGIE ATOMIQUE ET AUX ENERGIES ALTERNATIVES, Paris (FR); SALZGITTER MANNESMANN PRECISION ETIRAGE SAS, St-Florentin (FR)

(21) Appl. No.: 15/104,115

(22) PCT Filed: Dec. 12, 2014
(86) PCT No.: PCT/FR2014/053326

§ 371 Date: Jun. 13, 2016

(30) Foreign Application Priority Data
Dec. 13, 2013 (FR) 1302935

(51) Int. Cl. F24J 2/48; C23C 8/02; C23C 8/04; C23C 8/80; C23C 8/18; C22C 38/50; C22C 38/48; C22C 38/46; C22C 38/44; C22C 38/06; C22C 38/04; C22C 38/02; C22C 38/00; F24J 2/46; F28F 21/08; F24J 2/07; F27D 7/06; C23C 8/14

(52) U.S. Cl. CPC F24J 2/487; C23C 8/14; C23C 8/02; C23C 8/04; C23C 8/80; C23C 8/18; C22C 38/50; C22C 38/48; C22C 38/46; C22C 38/44; C22C 38/06; C22C 38/04; C22C 38/02; C22C 38/001; F24J 2/4652; F28F 21/083; F24J 2/07; F27D 7/06

(57) ABSTRACT

A method for producing a solar radiation absorber element, for a concentrating thermal solar power plant, including the formation of a selective coating on an outer surface of a steel substrate, formation of the selective coating including the following successive steps: providing a steel substrate having a chromium content between 6% and 12.5% by weight, and an aluminium content less than or equal to 0.05% by weight, performing heat treatment so as to form an oxide layer on the surface of the substrate.

### BACKGROUND OF THE INVENTION

The invention relates to a solar radiation absorber element for a concentrating thermal solar power plant and its production method, with in particular formation of a selective coating on an outer surface of a steel substrate.

### STATE OF THE ART

A concentrating solar power plant (CSP) is a power plant designed to concentrate the sun's rays by means of mirrors to heat a heat transfer fluid. The heat transfer fluid then acts as hot source in a thermodynamic cycle with a view to producing electricity. Concentration of the solar rays enables higher temperatures to be reached and makes it possible to take advantage of a higher thermodynamic conversion.

Different techniques exist for concentrating solar rays, to transport and possibly store the heat and to convert the heat into electricity. In all cases, one of the essential elements of a concentrating thermal solar power plant is the solar radiation absorber element which forms part of the receiver.

In order to maximise the efficiency of the absorber, the latter in general comprises a coating, called selective coating or selective treatment. The selective coating is designed to allow a maximal absorption of the incident solar energy while re-emitting the least possible infrared radiation (black body principle). In particular, such a selective coating is considered as being perfect if it absorbs all the wavelengths lower than a cut-off wavelength and reflects all the wavelengths higher than this same cut-off wavelength.

For example purposes, International application WO 2009/051595 proposes a solar selective coating covering the outer surface of a solar radiation absorber tube, typically made from stainless steel, and comprising a stack of several layers each having a function and a thickness determined by optic simulation. In a particular embodiment, the solar radiation absorber tube is successively covered by a succession of bilayers composed of a layer made from material reflecting IR radiation and a layer of material absorbing solar radiation, followed by application of an antireflection layer. The solar radiation absorber tube is for example made from stainless steel of austenitic structure, for example of AISI 316, 321, 347 or 304L type.

U.S. Pat. No. 4,268,324 and the article “Influence de l'oxydation et de la rugosité sur les caractéristiques radiatives des aciers inoxydables” by P. Demont (Journal of Physics, Colloquium C1, Volume 42, 1981) describe the use of a heat treatment to obtain an oxide layer at the surface of substrates made from stainless steel such as AISI 321, 304 and 316. The oxide layer plays the role of selective coating. The temperatures used for the heat treatment are comprised between about 300° C. and 1000° C. U.S. Pat. No. 4,268,324 stipulates that the optimum temperature for formation of the selective coating for AISI 321 stainless steel is 570° C., it is at this temperature that absorption of the oxide layer obtained is the highest while keeping a relatively low emissivity. International application WO 2012/168577 also describes the formation of an oxide layer at the surface of a stainless steel substrate by heat treatment. The heat treatment temperatures are comprised between 550° C. and 650° C. U.S. Pat. No. 4,097,311 describes the formation of an oxide layer at the surface of a stainless steel substrate by dipping in an oxidising bath at a temperature comprised between 70° C. and 120° C.

All these types of selective coatings do not enable the requirements of performance and of durability in time to be met simultaneously, in particular in an oxidising atmosphere. The coatings currently available on the market for high temperatures of use (typically higher than 400° C.) do in fact often require the use of a protective enclosure in a vacuum which both increases the manufacturing costs and gives rise to problems of stability in time. Furthermore, the substrates obtained in this way present risks of breaking by thermal fatigue, which reduces their lifetime.

### Object of the Invention

The object of the invention tends to propose a solar radiation absorber element, for a concentrating thermal solar power plant, comprising a selective coating that is efficient, durable and stable, not only for temperatures of use above 400° C., but also in an oxidising atmosphere such as air. The absorber element also has to present low risks of rupture by thermal fatigue. This object tends to be met by the appended claims.

### BRIEF DESCRIPTION OF THE DRAWINGS

Other advantages and features will become more clearly apparent from the following description of particular embodiments of the invention given for non-non-restrictive example purposes only and represented in the appended drawings, in which:

FIGS. 1 to 4 schematically represent, in cross-section, different steps of a method for producing a solar radiation absorber element according to the invention.

### DESCRIPTION OF PREFERRED EMBODIMENTS OF THE INVENTION

It is proposed to produce a solar radiation absorber element that is particularly suitable for concentrating thermal solar power plants and that remedies the drawbacks of the prior art.

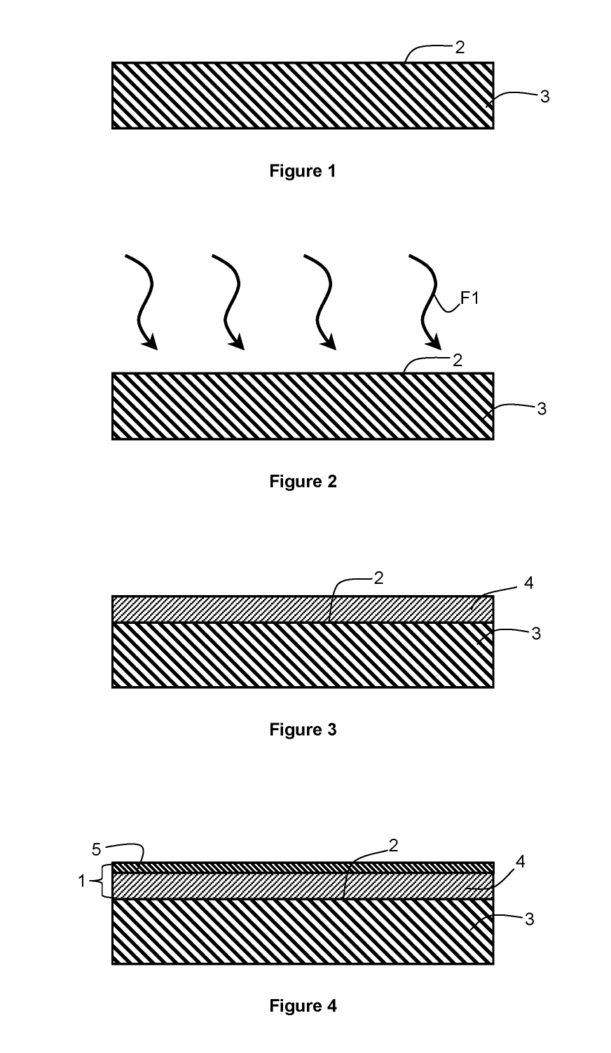

As illustrated in FIGS. 1 to 4, the method for producing a solar radiation absorber element for a concentrating thermal solar power plant comprises the formation of a selective coating 1 on an outer surface 2 of a steel substrate 3, formation of the selective coating 1 comprising the following successive steps:
providing a steel substrate 3,
performing heat treatment (arrows F1 in FIG. 2) so as to form an oxide layer 4 at the surface of the substrate 3.

The steel entering the composition of the substrate on which the selective coating is formed is specifically selected.

Preferentially, the steel is a steel that is referred to as being “highly alloyed”, i.e. it contains an alloy element present in a percentage of more than 5% weight with respect to the total weight of the steel.

Compared with stainless steels, highly alloyed steels have a better thermal conductivity, a lower thermal expansion coefficient and better mechanical properties. Advantageously, these properties make them less sensitive to thermal fatigue and enable a better heat transmission to be had from the outside of the tube to the heat transfer fluid.

The steel has a chromium content comprised between 6% and 12.5% by weight, and preferentially between 6% and 11.6% by weight, more preferentially between 6% and 11.5% by weight and even more preferentially between 6% and 10.5% by weight.

What is meant by chromium content of the steel is the percentage of chromium by weight with respect to the total weight of the elements constituting the steel. It is the minimum content or percentage generally added for a particular grade of steel.

The use of such a steel enables the heat conduction to be improved compared with a stainless steel. Advantageously, these steels present a lower thermal expansion, which enables the thermal stresses to be limited thereby limiting the rupture fatigue.

Furthermore, the steel of the substrate 2 can more specifically be chosen from steels presenting a nickel content of less than 1% by weight, and preferably from steels presenting a nickel content of less than 0.5%. Advantageously, the presence of nickel in these percentages enables the strength of the substrate to be increased.

The steel also presents an aluminium content of less than 1% by weight. Preferentially the aluminium content is less than or equal to 0.05%, and even more preferentially less than 0.04%.

Such an aluminum content advantageously improves the creep performances while sufficiently refining the grain of the matrix.

The steel of the substrate 2 is advantageously chosen from the steels designated by X11CrMo9-1, X10CrMoVNb9-1, X10CrWMoVNb9-2 and X11CrMoWVNb9-1-1 which respectively correspond to the steels defined by 1.7386, 1.4903, 1.4901 and 1.4905 according to the European numerical system (standard EN 10027-2), and from the steels T91 (K90901), T92 (K02460), T911 (K91061) and T122 (K91271) of the ASTM standards (UNS).

The steel can also be chosen from the steels designated by X20CrMoV11-1, X20CrMoV12-1 and X19CrMoNbVN11-1 which respectively correspond to the steels defined by 1.4922, 1.7175 and 1.4913 according to the DIN European numerical system (standard EN 10027-2).

According to a preferred embodiment, the composition of the steel is given in the table below:

TABLE 1

| (% by weight) | C | Mn | Si | Cr | Mo | V | W | Nb | N | Al | Ti | Ni |
|---|---|---|---|---|---|---|---|---|---|---|---|---|
| Min | 0.07 | 0.2 | 0.1 | 6 | 0.2 | 0 | 0 | 0 | 0 | 0 | 0 | 0 |
| Max | 0.23 | 1.30 | 1 | 11.6 | 2.3 | 0.4 | 2.5 | 0.6 | 0.08 | 0.04 | 0.1 | 0.5 |

Such a proportion of chromium in the steel enables a highly alloyed steel to be obtained. Advantageously, such a proportion of chromium enables an oxide layer to be obtained with improved optic properties, mechanical strength and stability in time.

The presence of carbon, manganese, molybdenum, vanadium and tungsten in these proportions in the substrate enables the mechanical properties of the oxide layer obtained by oxidation of the substrate to be improved.

The steel can also comprise impurities, for example of lead, tin, sulphur, phosphorus, arsenic, and antimony. What is meant by impurity is an element present in a percentage of less than 0.1% with respect to the total weight of the steel. The rest of the percentages by weight correspond to the percentage by weight of iron. The alloy contains at least 50% by weight of iron.

In addition, as the steels used present a good thermal conductivity and a low expansion coefficient, i.e. about 30% lower than that of austenitic stainless steels, the risks of rupture by thermal fatigue in use will thus be limited.

The steels used to produce the solar radiation absorber element have a much higher corrosion resistance than weakly alloyed alloys, containing in particular between 1 and 5% of chromium, such as for example 10CrMo9-10 steel; the mechanical properties are moreover also distinctly improved.

Advantageously, these alloys are more resistant when hot, which enables the thickness of the substrate used to be reduced and the thermal gradients and risks of rupture by thermal fatigue to be reduced.

The steel substrate 3 has a thickness between 1 mm and 8 mm. According to a preferred embodiment, the steel substrate 3 has a thickness comprised between 1 mm and 7 mm. Advantageously, the use of steel of small thicknesses enables the formation of residual stresses to be limited when heat treatment is performed.

In particular, the steel substrate 3 presents an outer surface 2 on which the selective coating is made. It can be of any type of shape suitable for its use as selective solar radiation absorber element, for a concentrating thermal solar power plant (for example a solar power plant of Fresnel or cylindro-parabolic type).

The use of a steel substrate presenting a chromium content comprised between 6% and 12.5%, and preferably between 6% and 11.6%, and even more preferably between 6% and 11.5% by weight enables an intrinsically selective superficial thin layer to be formed, by means of heat treatment, on the outer surface of said substrate. Advantageously, this also enables an oxide layer to be formed that is stable in time and that does not flake. The presence of the chromium contributes to the good mechanical properties as far as temperature is concerned.

What is meant by intrinsically selective superficial thin layer is a superficial thin layer which, due to its intrinsic nature, is able to absorb a maximum of incident solar energy and to re-emit a minimum of infrared radiation. What is meant by absorb a maximum of energy is that the superficial thin layer enables at least 75% of the solar radiation to be absorbed. What is meant by re-emit a minimum of infrared radiation is that the emissivity of the superficial thin layer is less than 25%.

Advantageously, the temperature of the heat treatment is higher than the operating temperature of the absorber element, i.e. the heat treatment temperature is higher than 400° C.

The selective coating 1, also called selective treatment, thus obtained is stable in air, for temperatures of use of more than 400° C., and presents a long lifetime, over a large number of years, for example about 20 years.

Preferentially, the heat treatment is performed at a temperature comprised between 400° C. and 900° C. And even more preferentially, the heat treatment is performed at a temperature comprised between 500° C. and 800° C.

In so far as the layer, responsible for the good optic properties of the surface, was formed at a higher temperature than its temperature of use, the oxide thus obtained, which mainly contains oxygen, iron and chromium, is stable during its use, including for a use in an oxidising atmosphere when thermal cycles are performed.

For example, the heat treatment is performed using a temperature increase rate of 5° C./min to 1° C./sec, preferentially of 0.3° C./s to 0.5° C./s.

The duration of the temperature plateau when the heat treatment is performed is comprised between 5 minutes and 240 minutes, depending on the temperature chosen and the temperature gradient used.

The heat treatment step enables a superficial thin layer 1 to be formed at the interface with the outer surface 2 of substrate 3. This heat treatment operation is symbolised by the arrows F1 in FIG. 2.

The heat treatment step is performed in an oxidising atmosphere, preferably a very weakly oxidising atmosphere.

What is meant by oxidising atmosphere is in general manner air, air enriched with dioxygen or air enriched with water vapour. The oxidising atmosphere contains at least 5% in volume of an oxygen precursor, for example O₂, H₂O, O₃.

What is meant by weakly oxidising atmosphere is an atmosphere with a low CO₂ content and a very low O₂ content.

Preferentially, the heat treatment is performed in air.

The superficial thin layer 1 is in particular obtained by oxidation of certain elements contained in the steel composing the substrate 2. It is therefore essentially composed of oxide.

Measurements made by X-ray diffraction have in particular highlighted that the superficial thin layer is composed of iron and chromium oxides. The oxide obtained is of (Fe,Cr)₂O₃ type.

The oxide layer is essentially composed of iron, chromium and oxygen.

What is meant by essentially composed of is that the oxide layer is formed by iron, chromium, and oxygen. The oxide layer may contain impurities.

The superficial thin layer 1 is in direct contact with the steel substrate 2. This superficial thin layer 1 being formed by oxidation of the substrate, it has an excellent adherence compared in particular with other layers deposited by thin layer depositions such as for example physical vapor deposition (PVD) or chemical vapor deposition (CVD).

The thickness of the oxide layer 4 formed is comprised between 10 nm and 1000 nm, and preferably between 20 nm and 500 nm. Even more preferably, the thickness of the oxide layer is comprised between 50 nm and 100 nm. The thicker the oxide, the better the absorption in the solar radiation range will be, but the more the emissivity of the selective treatment will increase in the infrared range. The person skilled in the trade will therefore choose thicknesses in the range mentioned in the foregoing.

According to a preferred embodiment, before or after the heat treatment step, a surface treatment is performed on the substrate 3 so as to obtain a roughness Ra of less than 1 μm, preferably less than 0.5 μm, according to the standard NF ISO 4287, for the outer surface 2 of the substrate 3.

The roughness Ra of the outer surface 2 of the substrate 3, after the heat treatment, is preferably comprised between 0.05 μm and 0.5 μm, which enables a layer to be obtained presenting a good absorption while at the same time presenting a low emissivity. What is meant by good absorption is an absorption of more than 0.75, and preferably more than 0.9, in the solar radiation wavelength range, and what is meant by low emissivity is an emissivity of less than 0.25 and preferably less than 0.2 in the relevant infrared range with respect to the intended application.

The lower the roughness, the lower the emissivity and absorption will be. A roughness comprised between 0.05 μm and 0.5 μm enables both a low emissivity and a good absorption of the received solar radiation to be obtained, while at the same time being feasible from an industrial standpoint.

To produce the selective coating 1 covering the outer surface 2 of the substrate 3, said outer surface 2 is therefore previously polished using conventional polishing methods or particular shaping methods.

Preferentially, the surface treatment is a mechanical polishing or an electrolytic polishing or a chemical surface treatment.

For example purposes, the mechanical polishing can be performed by means of a polishing paper of decreasing grain size (from P220 to P1200) and a felt imbibed with a suspension of monocrystalline diamonded particles having a diameter typically of 3 μm.

Among the shaping methods, the surface treatment can also be performed by cold drawing of the substrate. Drawing is a step which forms part of the manufacturing method of solderless tubes. Advantageously, drawing both enables the tube to be given its final dimensions and at the same time enables the surface of the tube to be structured so as to increase the absorption of the absorber element.

This surface treatment operation by polishing or cold drawing in particular enables the roughness state of the outer surface 2 of the substrate 3 to be mastered, before the heat treatment operation, and it has in particular an influence on the emissivity of the outer surface 3 in the infrared range.

As represented in FIG. 4, according to a particular embodiment, the method comprises deposition of an anti-reflective layer 5 on the oxide layer 4 at the surface of the substrate 3.

The assembly composed by the superficial thin layer 4 coated by the anti-reflective layer 5 then forms the selective coating 1 of the solar radiation absorber element.

The anti-reflective layer 5 advantageously enables the absorption to be enhanced. The anti-reflective layer 5 does not emit or hardly emits in the infrared in order not to impair the performances of the selective treatment.

The anti-reflective layer 5 is for example a layer of silicon oxide SiO₂, alumina Al₂O₃, silicon nitride, or titanium oxide TiO₂ or a combination of these different layers or products.

This layer will advantageously have a refraction index comprised between that of the substrate and that of air. The anti-reflective layer 5 has for example a refraction index comprised between 1.5 and 3.5, and preferably between 1.5 and 2.5.

Advantageously, it has a very low extinction coefficient in order to avoid an increase of the emissivity. Advantageously, the presence of the antireflective layer 5 must not increase the emissivity of the selective coating 1 of the absorber element by more than 5%.

The thickness of the anti-reflective layer 5 is comprised between 30 nm and 250 nm, and preferably between 50 nm and 200 nm, in order to obtain the best performances.

The optimal thickness is determined according to the target wavelength at which the quarter-wave filter has to be formed. The quarter-wave filter enables destructive interferences to be formed and the reflection to be minimised. For example, the wavelength chosen will make it possible to have a maximum absorption of the incident solar radiation around 500 nm.

The anti-reflective layer 5 is for example formed by a vacuum deposition technique such as physical vapour deposition (cathode sputtering or evaporation) or by chemical vapour deposition. According to a preferred embodiment, the anti-reflective layer is deposited by Plasma-Assisted Chemical Vapour Deposition (PACVD). Deposition by PACVD in ambient atmosphere enables an antireflective layer 5 to be produced at low cost as this deposition does not require working in a vacuum. What is meant by ambient atmosphere is a pressure of about 1 atm, i.e. of about 1013 hPa, and a temperature of about 20° C. to 25° C.

The PACVD technique makes it possible in particular to deposit oxide layers having low refraction indexes, such as layers of SiO₂ of index n=1.5, or high refraction indexes such as layers of TiO₂ of index n=2.55. It is therefore easy with this technique to produce a low-cost multilayer stack, each layer being able to have a different refraction index.

According to a particular embodiment, several layers of different index and thickness are arranged at the surface of the oxide thin layer in order to form a stack enabling the reflection to be reduced.

For example purposes, measurements of absorptance, emissivity and reflectance were made on an absorber element comprising a steel substrate of numerical designation 1.4903, also designated, depending on the standards of the countries by ASTM A-213 T91 or X10CrMoVNb9-1 (EN 10216-2).

The theoretical composition of the steel is indicated in the following table:

TABLE 2

| (% by weight) | C | Mn | Si | Cr | Mo | V | Ni |
|---|---|---|---|---|---|---|---|
| Theoretical | 0.07-0.14 | 0.3-0.6 | 0.2-0.5 | 8-9.5 | 0.85-1.05 | 0.18-0.25 | 0.03-0.07 |

Several measurement configurations were tested:
sample N°1 corresponds to the substrate T91 subjected to heat treatment in air for 1 h at 600° C.,
sample N°2 corresponds to sample N°1 which, in addition to the heat treatment, has undergone a first ageing step at 350° C. for 750 h and a second ageing step at 450° C. for 250 h,
sample N°3 corresponds to sample N°2 on which an anti-reflective layer has been deposited, i.e. sample N°3 corresponds to a substrate T91 subjected to heat treatment in air at 600° C. for 1 h, and then to a first ageing step at 350° C. for 750 h and to a second ageing step at 450° C. for 250 h, and on which an anti-reflective layer has finally been deposited,
sample N°4 corresponds to sample N°3 which, after deposition of the anti-reflective layer, has been subjected to an ageing step at 350° C. for 250 h,
sample N°5 corresponds to sample N°4 which has undergone an additional ageing step at 450° C. for 250 h.

The non-polished substrates generally present a roughness Ra of more than 1 μm. The polished substrates have undergone a mechanical polishing enabling a roughness Ra˜0.1 μm to be obtained.

The heat treatment is performed at a temperature of 600° C., in air, for 1 h. The heat treatment operation results in formation, directly on the outer surface of the substrate, of an oxidised superficial thin layer presenting an intrinsically selective nature. The oxide layer obtained has a thickness between 10 nm and 1000 nm, and preferably between 20 nm and 500 nm.

The anti-reflective layer 5 is deposited by PACVD at atmospheric pressure. It is made from SiO₂ and presents a thickness of about 80 nm.

The total reflectivity of the substrate was measured over a wavelength range of 320 nm to 10,000 nm.

These reflectivity measurements enable the absorption and emissivity levels, which are the surface properties sought for, to be calculated. The measurements were made in the visible radiation range (0.32 μm-2.5 μm) by means of a Perkin Elmer 950 lambda spectrophotometer, which has an integration sphere with a diameter of 150 mm, coated with BaSO₄. In the 2.5-10 μm range, the reflectance is measured by means of an Equinox 55 spectrophotometer, manufactured by Bruker and which has a gold-plated integration sphere which is highly reflective for these wavelengths.

The results of the optic measurements made on the samples are set out in the following table:

TABLE 3

| | N^{o}1 | | N^{o}2 | | N^{o}3 | | N^{o}4 | | N^{o}5 | |
|---|---|---|---|---|---|---|---|---|---|---|
| | NP | P | NP | P | NP | P | NP | P | NP | P |
| Absorptance | 77 | 72 | 78 | 73 | 85 | 82 | 81 | 81 | 83 | 81 |
| Reflectance | 23 | 28 | 22 | 27 | 15 | 18 | 19 | 19 | 17 | 19 |
| Emissivity at | 20 | 7 | 23 | 9 | 23 | 9 | 24 | 8 | 24 | 8 |
| 100° C. | | | | | | | | | | |
| Emissivity at | 24 | 11 | 27 | 12 | 27 | 12 | 28 | 12 | 27 | 11 |
| 300° C. | | | | | | | | | | |
| Emissivity at | 26 | 12 | 29 | 14 | 30 | 15 | 32 | 15 | 30 | 13 |
| 450° C. | | | | | | | | | | |

NP = Non-polished
P = Polished

The presence of the anti-reflective layer 5 in the selective coating covering the steel substrate 3 enables a gain of 7 to 9% in absorption to be obtained without modifying the emissivity of the anti-reflective layer.

The use of a substrate 3 presenting a roughness Ra of less than 0.4 μm enables a selective treatment to be obtained presenting a significantly lower emissivity than that obtained for substrates having higher roughnesses, typically more than 1 μm.

It has also been observed that these performances are stable, even after the ageing steps of the solar absorber at 350° C. and 450° C.

The oxide layer 4 formed on the outer surface 2 of the substrate 3 is a stable oxide layer at temperatures higher than the temperature of use of the solar radiation absorber element (typically higher than 400° C.) and under oxidising conditions (in particular in air).

The formation of such a superficial thin layer thus enables the selective coating, which comprises it, to be efficient, durable and stable for temperatures of use up to typically 500° C., which is the conventional operating temperature of solar radiation absorber elements. In addition, the production of such a superficial thin layer is easy to implement and inexpensive, as the thermal treatment enabling superficial oxidation of the substrate to be performed is a treatment that is simple to set up on an industrial scale.

Steels having a chromium content of less than 11.6% mass or even 11.5% mass have the reputation of forming an oxide that is not stable in time. However, it has been shown that under the conditions described above, the oxide formed at the surface of the substrate is stable under the conditions of use of a solar power plant (in air and at operating temperatures of less than 500° C.) and has good optic properties.

Advantageously, steel tubes of large length will be used in order to limit the number of welds to be made in order to obtain a tube of large length. Welds are in fact more difficult to achieve on highly alloyed steels compared with weakly alloyed steels or stainless steels.

The steel substrates selected in the above-mentioned range will be able to be used in installations operating at higher temperatures: typically up to a heat transfer fluid temperature of 550° C., for pressures comprised between 3 bar and 150 bar for example, and up to a temperature of 600° C. for use at low pressure, close to atmospheric pressure, between 1 and 5 bar.

These steels are particularly advantageous to act as substrate for producing absorber elements in direct contact with a heat transfer fluid such as water vapour, a heat conductor which benefits from a large experience feedback in thermal power plants in particular.

The absorber elements presented above are suitable for solar power plants of Fresnel and cylindro-parabolic type requiring a stable selective treatment in air, in particular for temperatures of more than 400° C. Given the thermal properties of such steels and their lower manufacturing cost than stainless steels, these steels can also be used for producing absorbers in the form of a bundle of tubes having unitary lengths that are able to be up to several hundred metres.

Manufacturing of a concentrating thermal solar power plant comprises for example the following steps:
providing a steel substrate 3 having an outer surface 2 covered by a selective coating 1 selective to solar radiation, the substrate 3 being designed to form a cavity through which a heat transfer fluid can flow; the most conventional shape of this substrate notably being the cylindrical tube,
providing at least one mirror arranged to concentrate a part of the received solar radiation onto the substrate 3.

The manufacturing method of a concentrating thermal solar power plant also comprises the following steps:
providing a steel substrate 3 having a chromium content comprised between 6% and 12.5% by weight, and preferably comprised between 6% and 11.6% by weight, and even more preferably comprised between 6% and 11.5%,
performing heat treatment so as to form an oxide layer 4 intrinsically selective to solar radiation at the surface of the substrate 3.

The method for producing such a surface also comprises a surface treatment step of the substrate so as to obtain a substrate roughness of less than 0.5 μm. The surface treatment step is performed before or after the heat treatment.

1-25. (canceled)

26. A method for producing a solar radiation absorber element, for a concentrating thermal solar power plant, comprising forming a selective coating on an outer surface of a steel substrate, forming the selective coating comprises the following successive steps
providing a steel substrate notably having a chromium content comprised between 6% and 12.5% by weight, and an aluminum content less than or equal to 0.05% by weight,
performing heat treatment in an oxidising atmosphere containing at least 5% of an oxygen precursor so as to form an oxide layer at the surface of the steel substrate, an thickness of the oxide layer being comprised between 10 nm and 1000 nm.

27. Method according to claim 26, wherein the steel substrate has a carbon content comprised between 0.07% and 0.23%.

28. Method according to claim 26, wherein the steel substrate has a manganese content comprised between 0.2% and 1.3%.

29. Method according to claim 26, wherein the steel substrate has a molybdenum content comprised between 0.2% and 2.3%.

30. Method according to claim 26, wherein the steel substrate has a tungsten content comprised between 0% and 2.5%.

31. Method according to claim 26, wherein the steel substrate has a vanadium content comprised between 0% and 0.4%.

32. Method according to claim 26, wherein the steel substrate is chosen from steels designated by X11CrMo9-1, X10CrMoVNb9-1, X10CrWMoVNb9-2, X11CrMoWVNb9-1-1, X20CrMoV11-1, X20CrMoV12-1 and X19CrMoNbVN11-1.

33. Method according to claim 26, wherein the thickness of the oxide layer is comprised between 20 nm and 500 nm.

34. Method according to claim 26, wherein the heat treatment is performed at a temperature comprised between 400° C. and 900° C.

35. Method according to claim 26, wherein the oxide layer is essentially composed of iron, chromium and oxygen.

36. Method according to claim 26, wherein, before the heat treatment step, a surface treatment is performed on the steel substrate so as to obtain a roughness Ra of less than 1 μm for the outer surface of the steel substrate.

37. Method according to claim 36, wherein the roughness Ra is comprised between 0.05 μm and 0.5 μm.

38. Method according to claim 26, wherein the surface treatment chosen among a mechanical polishing, an electrolytic polishing or a chemical surface treatment or the surface treatment is performed by cold drawing of the steel substrate.

39. Method according to claim 26, further comprising deposition of an anti-reflective layer on the oxide layer at the surface of the steel substrate.

40. Method according to claim 39, wherein the anti-reflective layer is deposited by plasma-enhanced chemical vapour deposition at atmospheric pressure.

41. Method according to claim 39, wherein the anti-reflective layer is made from SiO₂, Al₂O₃, TiO₂, or a combination of these different layers.

42. Method according to claim 39, wherein the anti-reflective layer has a thickness comprised between 30 nm and 250 nm.

43. Method according to claim 26, wherein the steel substrate has a thickness comprised between 1 mm and 8 mm.

44. Solar radiation absorber element for a concentrating thermal solar power plant, comprising:
a steel substrate presenting a chromium content comprised between 6% and 12.5% by weight, and an aluminum content less than or equal to 0.05% by weight,
an oxide layer at a surface of the steel substrate, a thickness of the oxide layer is comprised between 10 nm and 1000 nm.

45. Absorber element according to claim 44, wherein the thickness of the oxide layer is comprised between 20 nm and 500 nm.

46. Absorber element according to claim 44, wherein steel of the steel substrate presents a carbon content comprised between 0.07% and 0.23%.

47. Absorber element according to claim 44, wherein steel of the steel substrate is chosen from steels designated by X11CrMo9-1, X10CrMoVNb9-1, X10CrMoVNb9-2 and X11CrMoWVNb9-1-1, T9, T91, T92, T911, and T122.

48. Absorber element according to claim 44, wherein an anti-reflective layer is arranged on the oxide layer.

49. Absorber element according to claim 44, wherein the oxide layer is essentially composed of iron, chromium and oxygen.

50. Absorber element according to claim 44, wherein the steel substrate has a thickness comprised between 1 mm and 8 mm.
